(19) United States
(12) Patent Application Publication
(10) Pub. No.: US 2007/0092791 A1
(43) Pub. Date: Apr. 26, 2007

(54) RECHARGEABLE BATTERY, METHOD FOR MANUFACTURING RECHARGEABLE BATTERY, AND COLLECTOR PLATE FOR RECHARGEABLE BATTERY

(75) Inventors: Kiyoshi HAYASHI, Kosai-shi, Shizuoka (JP); Hideki KASAHARA, Kosai-shi, Shizuoka (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: PANASONIC EV ENERGY CO., LTD., Kosai-shi (JP)

(21) Appl. No.: 11/551,185

(22) Filed: Oct. 19, 2006

(30) Foreign Application Priority Data
Oct. 21, 2005 (JP) 2005-307269

(51) Int. Cl. H01M 2/26; H01M 10/04

(52) U.S. Cl. 429/161; 429/211; 29/623.1

(57) ABSTRACT

A rechargeable battery for eliminating the need for attaching a joining metal member to a collector plate, while lowering the cost for forming collector plates and lowering resistance in the collector plate and in a joining portion. The rechargeable battery includes an electrode plate group formed by alternately superimposing positive electrode plates having positive electrode plate collector portions and negative electrode plates having negative electrode plate collector portions with separators arranged therebetween. Collector plates, formed by metal plates, are joined to the corresponding positive and negative electrode plate collector portions. Each collector plate is bent at a predetermined portion to form a joining portion having a ridge-shaped cross-section. The joining portion of each collector plate is pressed into the edge of the corresponding electrode plate collector portion and joined to the electrode plate collector portion by performing resistance welding.

### CROSS-REFERENCE TO RELATED APPLICATIONS

This application is based upon and claims the benefit of priority from the prior Japanese Patent Application No. 2005-307269, filed on Oct. 21, 2005, the entire contents of which are incorporated herein by reference.

### BACKGROUND OF THE INVENTION

The present invention relates to an improvement in a rechargeable battery, and more particularly, to a rechargeable battery in which a collector of an electrode plate included in an electrode plate group is joined to a collector plate at a low cost, a method for manufacturing such a rechargeable battery, and a collector plate for such a rechargeable battery.

Japanese Laid-Open Patent Publication Nos. 2001-93505 and 2003-36833 describe methods for joining an electrode plate collector portion of an electrode plate group, which is formed by superimposing positive and negative electrode plates with separators arranged therebetween, to a collector plate. In the described methods, wax is applied to a portion where a collector plate and an electrode plate collector portion are joined with each other. The joining portion is heated to melt the wax and join the electrode plate collector portion and the collector plate.

The structure of the electrode plate group and the method for joining the electrode plate collector portion and the collector plate described in Japanese Laid-Open Patent Publication No. 2001-93505 will now be described with reference to FIGS. 1 and 2. As shown in FIGS. 1A and 1B, an electrode plate group 1 includes a plurality of positive electrode plates 2 and a plurality of negative electrode plates 3, which are arranged alternately. Each positive electrode plate 2 is covered by a bag-like separator 4. Accordingly, the positive electrode plates 2 and the negative electrode plates 3 are superimposed with the separators 4 arranged therebetween. The portion shown by slanted lines in FIG. 1A indicates a power generation area. In this area, the positive and negative electrode plates 2 and 3 facing each other with the separators 4 arranged therebetween generate power. Positive electrode plate collector portions (leads) 5 are formed at one side of the positive electrode plates 2. Negative electrode plate collector portions (leads) 6 are formed at one side of the negative electrode plates 3. The electrode plate collector portions 5 and 6 are arranged in a manner that the positive electrode plate collector portions 5 project from one side of the electrode plate group 1 and the negative electrode plate collector portions 6 project from the other side of the electrode plate group 1 opposite the positive electrode plate collector portions 5. A collector plate 21 is joined to the edges of the electrode plate collector portions 5. A collector plate 22 is joined to the edges of the electrode plate collector portions 6. Each of the electrode plate collector portions 5 and 6 has alignment holes 7. Outer separators 8 are joined to the electrode plate group 1.

As shown in FIG. 2A, grooves 23 are formed in each of the collector plates 21 and 22 at appropriate intervals in the longitudinal direction of the collector plates 21 and 22. As shown in FIG. 2B, wax 24 is applied to each groove 23 at portions facing the electrode plate collector portion 5 or 6. The collector plates 21 and 22 are set on the electrode plate collector portions 5 and 6 of the electrode plate group 1 and pressed toward the electrode plate group 1 in the direction indicated by the white arrows 25. Then, a laser beam 26 or electron beam irradiates the rear of the collector plates 21 and 22 and scans each groove 23 in the direction indicated by arrow. This heats and melts the wax 24. As a result, the electrode plate collector portions 5 and 6 and the collector plates 21 and 22 are joined together.

FIG. 3A is a perspective view showing a collector plate 31 in another prior art example. The collector plate 31 has a plurality of notches 32 and 33, which are in arranged in a zigzag pattern. Joining projections 34 are formed in the notches 32 and 33. As shown in FIG. 3B, a plurality of sawtoothed projections 35 are formed on the distal end of each joining projection 34. The projections 35 are engaged with the edge of the corresponding electrode plate collector portions 5 and 6. This prevents the joining projections 34 and from being disengaged from the electrode plate collector portions 5 and 6 even when the joining projections 34 are strongly pressed against the electrode plate collector portions 5 and 6. Accordingly, the collector plate 31 and the electrode plate collector portion 5 or 6 are resistance-welded in a state in which an appropriate pressure is applied. Japanese Laid-Open Patent Publication No. 2001-148239 describes an example of the method shown in FIGS. 3A and 3B.

In the methods described in Japanese Laid-Open Patent Publication Nos. 2001-93505 and 2003-36833 (FIGS. 1 and 2), the wax 24 must be applied in advance to the collector plates 21 and 22. This increases work and cost.

In the method described in Japanese Laid-Open Patent Publication No. 2001-148239 (FIG. 3), the collector plate 31 is resistance-welded. This does not require much work and cost when the collector plate 31 is joined with electrode plate collector portions. However, this method requires the notches 32 and 33 to be formed in the collector plate 31 so that the joining projections 34 for resistance-welding can be formed. The notches 32 and 33 increase the electric resistance of the collector plate 31. Accordingly, this method is problematic in that it cannot satisfy the high output and high performance requirements of a battery used as a power supply for driving, for example, a hybrid vehicle or an electric automobile.

### SUMMARY OF THE INVENTION

The present invention provides a rechargeable battery that eliminates the need for a process for separately forming a joining member such as a joining metal member on a collector plate, uses an inexpensive collector plate that does not require much work and cost, and lowers the resistance in the collector plate and a joining portion of the collector plate. The present invention also provides a method for manufacturing such a rechargeable battery and a collector plate for such a rechargeable battery.

One aspect of the present invention is a rechargeable battery provided with an electrode plate group having a first edge and a second edge and including a positive electrode plate having a positive electrode plate collector portion defined on the first edge and a negative electrode plate having a negative electrode plate collector portion defined on the second edge. A first collector plate is joined to the positive electrode plate collector portion and a second collector plate is joined to the negative electrode plate collector portion. Each of the first and second collector plates includes a joining portion formed by bending a predetermined part of the collector plate so that the joining portion has a ridge-shaped cross-section. The joining portion is pressed into and joined to the corresponding electrode plate collector portion.

Another aspect of the present invention is a method for manufacturing a rechargeable battery. The method includes preparing an electrode plate group having a first edge and a second edge. The electrode plate group includes a positive electrode plate having a positive electrode plate collector portion defined on the first edge and a negative electrode plate having a negative electrode plate collector portion defined on the second edge. Further, the method includes preparing a first collector plate joined to the positive electrode plate collector portion and a second collector plate joined to the negative electrode plate collector portion. Each of the first and second collector plates are formed from a metal plate. The method also includes forming a joining portion having a ridge-shaped cross-section on each of the first and second collector plates by bending a predetermined part of each of the first and second collector plates, forcing the first collector plate against the positive electrode plate collector portion and the second collector plate against the negative electrode plate collector portion to press the joining portion of each of the first and second collector plates into the corresponding electrode plate collector portion, and joining each of the first and second collector plates to the corresponding electrode plate collector portion by melting an area of contact between the joining portions of each of the first and second collector plates and the corresponding electrode plate collector portion and the vicinity thereof.

A further aspect of the present invention is a collector plate for a rechargeable battery provided with an electrode plate group having a first edge and a second edge and including a positive electrode plate having a positive electrode plate collector portion defined on the first edge and a negative electrode plate having a negative electrode plate collector portion defined on the second edge. The collector plate is provided with a metal plate including a predetermined part and a joining portion formed by the predetermined part of the collector plate so that the joining portion has a ridge-shaped cross-section. The joining portion is joinable to the positive electrode plate collector portion or the negative electrode plate collector portion.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a schematic front view showing an electrode plate group and collector plates for a rechargeable battery in a prior art example;

FIG. 1B is a schematic cross-sectional view taken along line A-A in FIG. 1A;

FIG. 2A is a schematic perspective view showing a process for joining the electrode plate group and the collector plates of FIG. 1A;

FIG. 2B is a schematic cross-sectional view of grooves shown in FIG. 2A;

FIG. 3A is a schematic perspective view showing a collector plate for a rechargeable battery in another prior art example;

FIG. 3B is an enlarged view showing area B encircled in FIG. 3A;

FIG. 4 is a schematic front view showing a joined state of an electrode plate group and a collector plate for a rechargeable battery according to a first embodiment of the present invention;

FIG. 5A is a schematic front view showing the electrode plate collector and the collector plate of FIG. 4 before they are joined with each other;

FIG. 5B is a schematic front view showing the electrode plate collector portion and the collector plate of FIG. 5A after they have been joined together;

FIG. 5C is a perspective view of a joining portion shown in FIG. 5A;

FIG. 5D is a perspective view of a melted portion shown in FIG. 5B;

FIG. 6A is a schematic front view showing a collector plate and an electrode plate collector portion before they are joined together in a modification of the first embodiment;

FIG. 6B is a schematic front view showing the collector plate and the electrode plate collector portion of FIG. 6A after they have been joined together;

FIG. 6C is a perspective view of a joining portion shown in FIG. 6A;

FIG. 6D is a perspective view showing a melted portion shown in FIG. 6B;

FIG. 7A is a schematic front view showing a collector plate and an electrode plate collector portion for a rechargeable battery according to a second embodiment of the present invention before the collector plate and the electrode plate are joined together;

FIG. 7B is a schematic front view showing a collector plate and an electrode plate collector portion before they are joined together in a modification of the second embodiment;

FIG. 7C is a perspective view of a joining portion shown in FIG. 7A;

FIG. 7D is a perspective view of a joining portion shown in FIG. 7B;

FIG. 8A is a schematic front view showing an electrode plate collector portion in a modification of the second embodiment;

FIG. 8B is a schematic front view showing an electrode plate collector portion in a modification of the second embodiment;

FIG. 9A is a schematic front view showing an electrode plate collector portion and a collector plate for a rechargeable battery according to a third embodiment of the present invention before the collector plate and the electrode plate are joined together; and

FIG. 9B is a schematic front view showing the electrode plate collector portion and the collector plate of FIG. 9A after they have been joined together.

### DETAILED DESCRIPTION OF THE PREFERRED EMBODIMENTS

In the drawings, like numerals are used for like elements throughout.

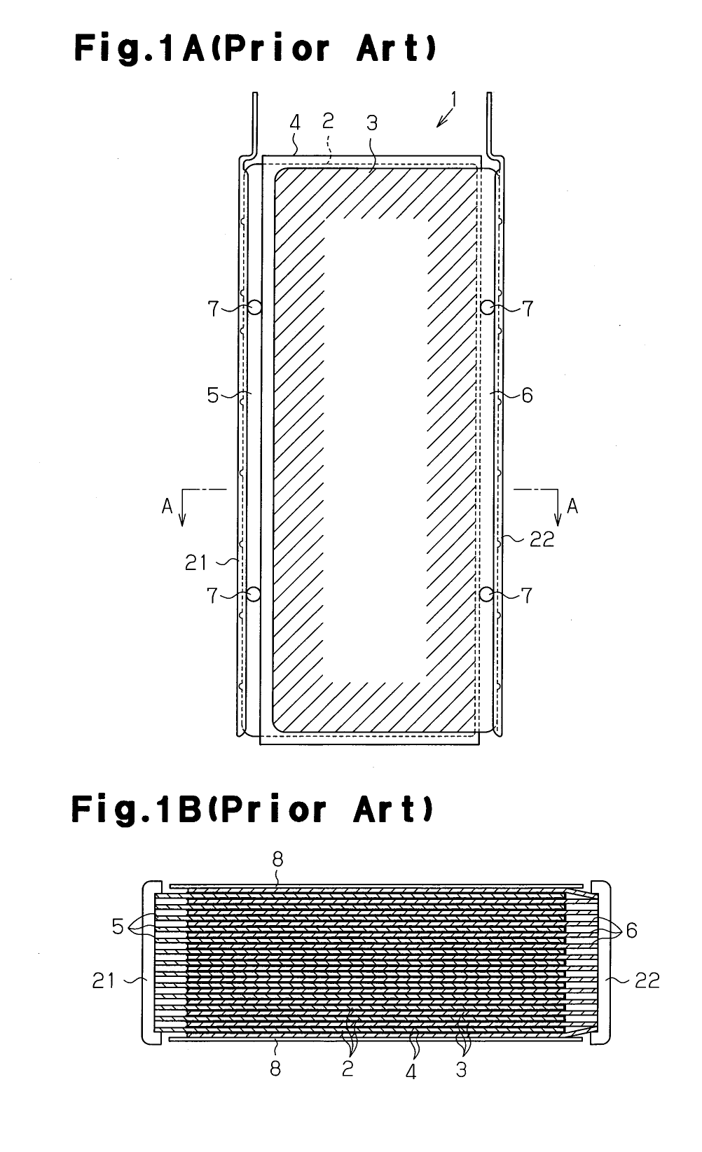

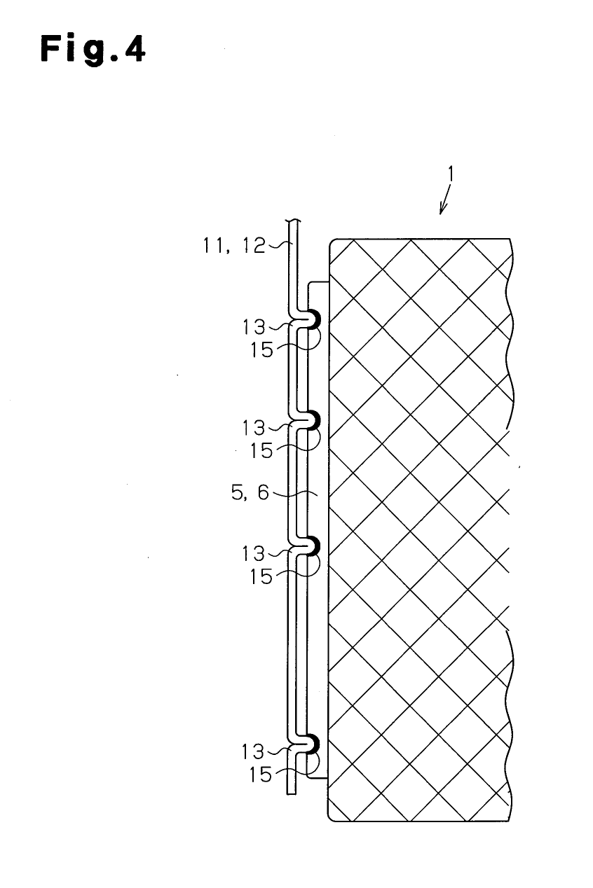

A rechargeable battery according. to a first embodiment of the present invention will now be described with reference to FIGS. 4 to 6. The overall structure of the rechargeable battery in the first embodiment is based on the structure described in Japanese Laid-Open Patent Publication No. 2001-93505. Further, the overall structure of an electrode plate group 1 in the rechargeable battery of the first embodiment is roughly based on the structure described in FIG. 1. The components of the rechargeable battery of the first embodiment that are identical to the components in the prior art example are denoted by the same reference numerals and will not be described.

Referring to FIG. 4, the electrode plate group 1 is formed by alternately superimposing positive electrode plates 2 and negative electrode plates 3 with separators 4 arranged therebetween. The electrode plate group 1 of the first embodiment is incorporated in, for example, a nickel-metal hydride rechargeable battery. The positive electrode plates 2 are formed by filling a foam metal of nickel with a positive electrode active material, which is mainly composed of nickel hydroxide. The negative electrode plates 3 are formed by applying a negative electrode active material, which is mainly composed of a hydrogen storing alloy, to a punching metal of nickel. Positive electrode plate collector portions (leads) 5, which are formed on the positive electrode plates 2, project from one side (first side) of the electrode plate group 1. Negative electrode plate collector portions (leads) 6, which are formed on the negative electrode plates 3, project from the other side (second side) of the electrode plate group 1. A positive collector plate 11 (first collector plate) is joined to the electrode plate collector portions 5. A negative collector plate 12 (second collector plate) is joined to the electrode plate collector portions 6. Each of the collector plates 11 and 12 is formed by a metal plate, or more specifically, a nickel-plated steel plate having a plate thickness of about 0.5 to 1.0 mm.

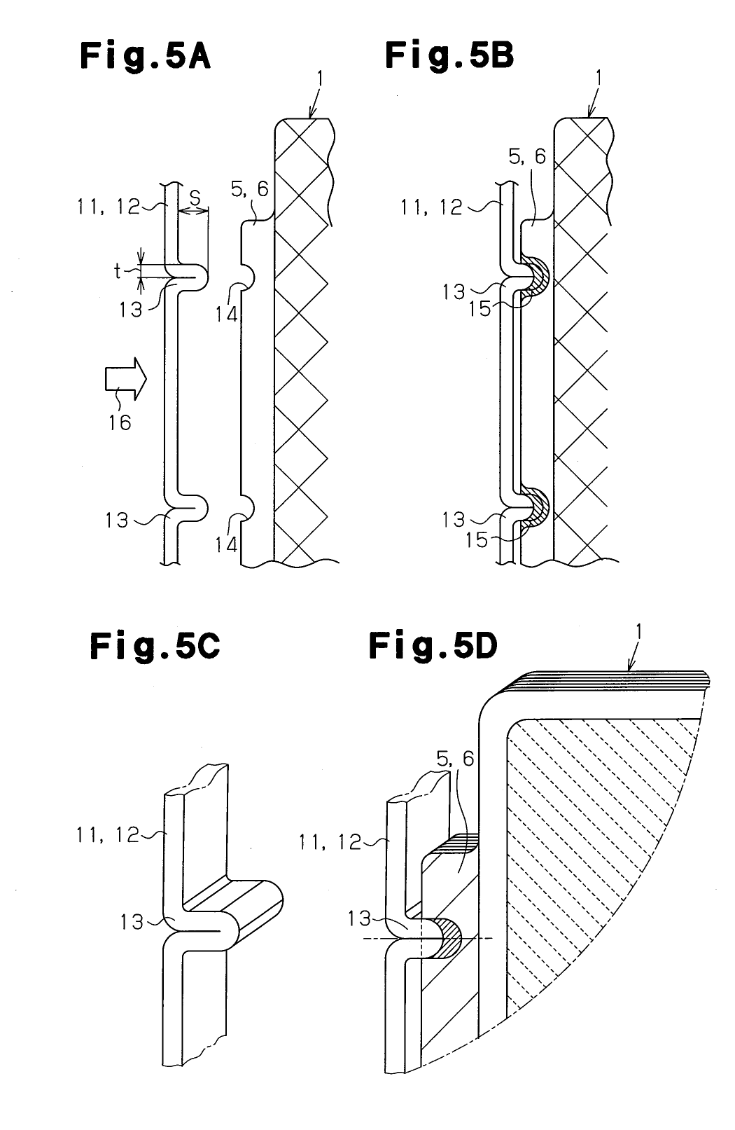

As shown in FIGS. 4 and 5C, each of the collector plates 11 and 12 has joining portions 13 formed at appropriate intervals in the longitudinal direction of the collector plates 11 and 12. The joining portions 13 are formed by bending the collector plates 11 and 12 into U-shapes so that the joining portions 13 have ridge-like cross-sections. The joining portions 13 of the first embodiment are formed by bending the metal plates forming the collector plates 11 and 12 without changing the plate thickness in a manner that inner surfaces of the ridges defining each joining portion 13 come in contact with each other. The projecting height of each joining portion 13 is preferably about one-half to two-third the width of the electrode plate collector portions 5 and 6. More specifically, the projecting height of each joining portion 13 is 1.0 to 3.0 mm when the width of the electrode plate collector portions 5 and 6 is 2.0 to 5.0 mm.

The electrode plate collector portions 5 and 6 of the electrode plate group 1 have recesses 14, which are formed in advance before the electrode plate collector portion portions 5 and 6 and the collector plates 11 and 12 are joined together. The recesses 14 are formed at positions joined to the joining portions 13 so as to receive the distal ends of the joining portions 13. More specifically, each recess 14 is semi-circular shape and has a radius equal to the plate thickness of the collector plates 11 and 12.

The procedure for joining the collector plates 11 and 12 to the electrode plate collector portions 5 and 6 of the electrode plate group 1 will now be described. First, as shown in FIG. 5A, the joining portions 13 of the collector plates 11 and 12 are arranged to face the recesses 14 formed in the edges of the electrode plate collector portions 5 and 6. In this state, force is applied to the collector plates 11 and 12 in the direction indicated by arrow 16 so that the joining portions 13 are pressed into the recesses 14 in the edges of the electrode plate collector portions 5 and 6. In a state in which the collector plates 11 and 12 are forced against the electrode plate collector portions 5 and 6, weld electrodes (not shown) are pressed against the rear sides of adjacent or different joining portions 13 of the collector plates 11 and 12. Then, resistance welding is performed as welding current flows through the weld electrodes. As shown in FIG. 5B, this melts the area of contact between the joining portions 13 and the electrode plate collector portions 5 and 6 and it's surrounding and forms melted portions 15. In this manner, the electrode plate collector portions 5 and 6 and the collector plates 11 and 12 are joined together by the melted portions 15 as shown in FIG. 5D.

As described above, the joining portions 13 to which the electrode plate collector portions 5 and 6 are joined are formed by bending the collector plates 11 and 12. This structure eliminates the need for a process for separately forming a joining member, such as a joining metal member, on the collector plates 11 and 12. Thus, the collector plates 11 and 12 can be easily formed. This reduces the cost of the collector plates 11 and 12. Further, since notches do not have to be formed in the collector plates 11 and 12, the electric resistance of the collector plates 11 and 12 is lowered. As described above, the joining portions 13 of the collector plates 11 and 12 are pressed into the electrode plate collector portions 5 and 6, and the areas of contact between the joining portions 13 and the electrode plate collector portions 5 and 6 and their surroundings are melted to form the melted portions 15. The melted portions 15 join the electrode plate collector portions 5 and 6 to the collector plates 11 and 12. This ensures that the joining portions 13 of the collector plates 11 and 12 are joined to the electrode plate collector portions 5 and 6. The joining resistance of the joining portions 13 and the electrode plate collector portions 5 and 6 is also reduced.

Further, the joining portions 13 are formed in a manner that the inner surfaces of ridges defining each joining portion 13 come in contact with each other. The width of the electrode plate collector portions 5 and 6 into which the joining portions 13 are pressed is constant and small. Thus, the joining portions 13 can be easily and deeply pressed into the electrode plate collector portions 5 and 6. Further, the joining portions 13 are pressed into the electrode plate collector portions 5 and 6 with sufficient strength and rigidity. Additionally, the electrode plate collector portions 5 and 6 have the recesses 14 formed at positions joined with the joining portions 13. The recesses 14 are formed to receive the distal ends of the joining portions 13. Thus, movement and separation of the electrode plate collector portions 5 and 6 are prevented when the collector plates 11 and 12 are strongly forced against the electrode plate collector portions 5 and 6 to press the joining portions 13 into the electrode plate collector portions 5 and 6. This ensures that the joining portions 13 are pressed into the electrode plate collector portions 5 and 6 and increases the joining reliability.

Furthermore, the resistance welding easily obtains a highly-reliable joining state of the plate collector portions 5 and 6 and the collector plates 11 and 12. This reduces the cost of the collector plates 11 and 12. Additionally, the resistance is reduced in the collector plates 11 and 12 and the joining portions of the collector plates 11 and 12.

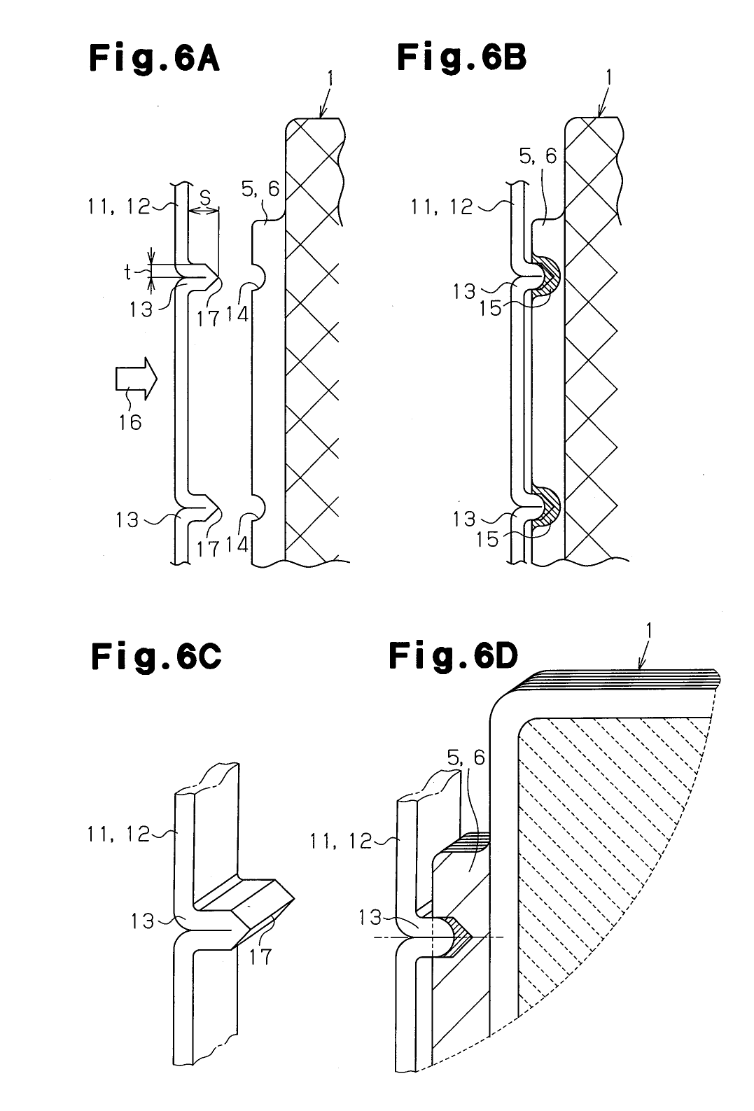

Each joining portion 13 does not have to be bent so that its distal end has a round shape (FIGS. 4 and 5). For example, each joining portion 13 may be pressed or ground so that its distal end forms an acute end 17 as shown in FIGS. 6A, 6B, 6C, and 6D. Although the recesses 14 of the electrode plate collector portions 5 and 6 have semi-circular shapes in the example shown in FIGS. 6A to 6D, the recesses 14 may have triangular shapes corresponding to the acute ends 17 of the joining portions 13. When the joining portions 13 have the acute ends 17, the joining portions 13 are easily and deeply pressed into the electrode plate collector portions 5 and 6. This ensures that the joining state can be easily obtained with a small joining resistance.

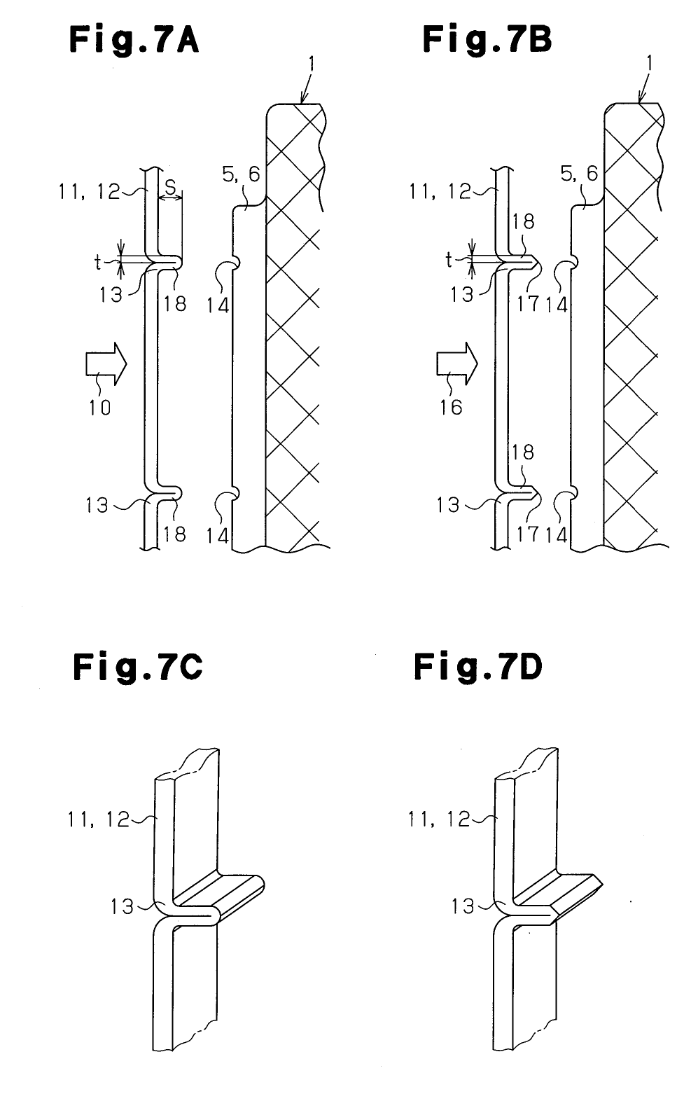

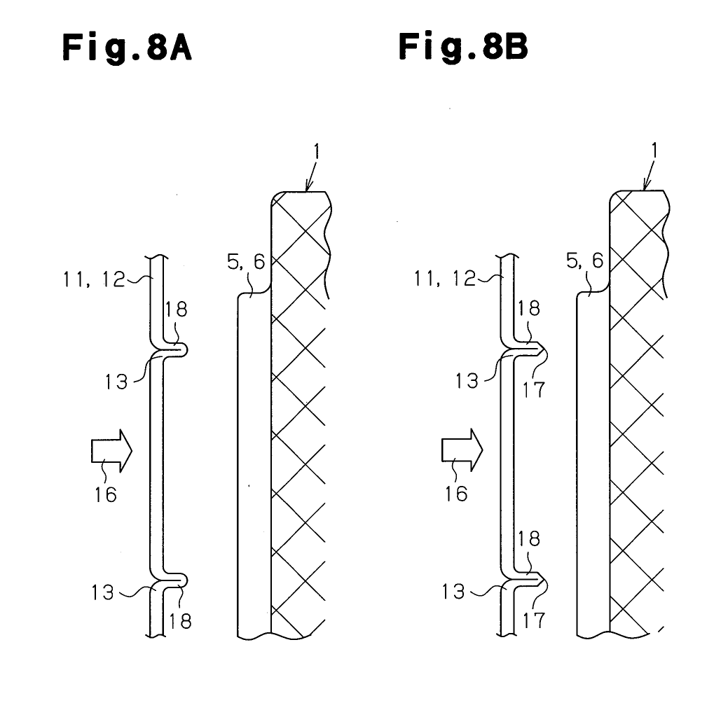

A second embodiment of the present invention will now be described with reference to FIGS. 7 and 8. To avoid redundancy, like or same reference numerals are given to those components that are the same as the corresponding components of the first embodiment and will not be described. The second embodiment will be described focusing only on the differences from the first embodiment.

In the second embodiment, collector plates 11 and 12 have thin portions 18. Referring to FIGS. 7A and 7C, the thin portions 18 are formed by rolling the parts of the collector plates 11 and 12 at which joining portions 13 are formed or at least the parts of the collector plates 11 and 12 at which the distal ends of the joining portions 13 are formed. The joining portions 13 are formed by bending the thin portions 18. The thin portions 18 preferably have a plate thickness of about one-half to one-third the original plate thickness of the collector plates 11 and 12. The electrode plate collector portions 5 and 6 have recesses 14 formed and sized in correspondence with the joining portions 13, which are formed by the thin portions 18. More specifically, each recess 14 has a semi-circular shape with a radius equal to the plate thickness of the thin portions 18.

In the second embodiment, the joining portions 13, especially, the distal ends of the joining portions 13 have a plate thickness that is less than the other portions of the collector plates 11 and 12. This facilitates bending when forming the joining portions 13 and easily presses the joining portions 13 into the electrode plate collector portions 5 and 6. The plate thickness at the joining portions 13 is at least one-third the plate thickness of the other parts of collector plates 11 and 12. This prevents the joining portions 13 from increasing the electric resistance.

In the second embodiment, the distal ends of the joining portions 13 may be formed into acute ends 17 as shown in FIGS. 7B and 7D. This enables the joining portions 13 to be easily pressed into the electrode plate collector portions 5 and 6. Since the joining portions 13 may easily be pressed into the electrode plate collector portions 5 and 6 in the second embodiment, the recesses 14 may be eliminated from the electrode plate collector portions 5 and 6 as shown in FIG. 8A. Further, when the distal ends of the joining portions 13 are formed into the acute ends 17 as shown in FIG. 8B, the joining portions 13 are more easily pressed into the electrode plate collector portions 5 and 6 even when the recesses 14 are not formed.

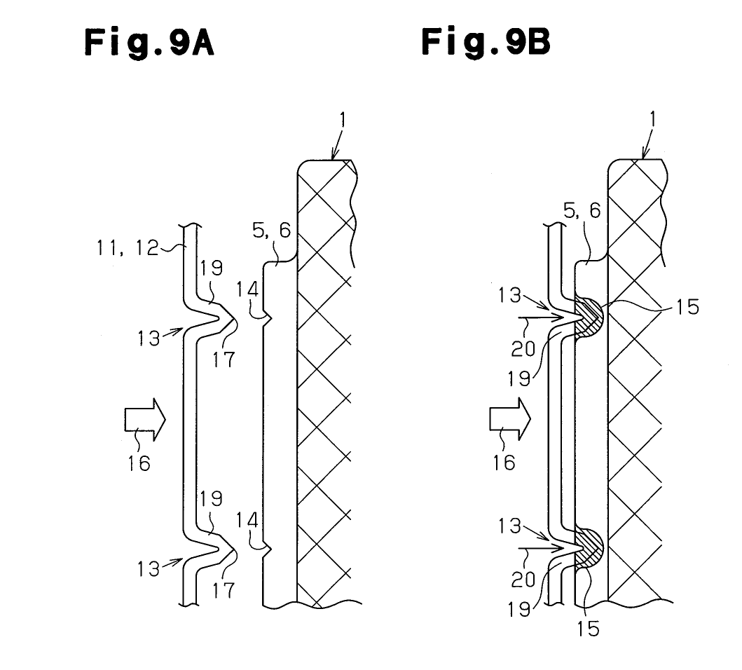

A third embodiment of the present invention will now be described with reference to FIG. 9.

In the third embodiment, joining portions 13 of collector plates 11 and 12 are bent into V-shapes to form V-shape bent portions 19. The distal ends of the V-shape bent portions 19 are formed into acute ends 17. Electrode plate collector portions 5 and 6 have recesses 14 with triangular shapes formed in correspondence with the acute ends 17 of the V-shape bent portions 19. As shown in FIG. 9A, the joining portions 13 of the collector plates 11 and 12 are arranged to face the recesses 14 formed in the edges of the electrode plate collector portions 5 and 6. In this state, force is applied to the collector plates 11 and 12 in the direction indicated by arrow 16 so that the joining portions 13 are pressed into the edges of the electrode plate collector portions 5 and 6. While the collector plates 11 and 12 are being forced against the electrode plate collector portions 5 and 6, a laser beam 20 or electron beam irradiates (scans) the rear of the joining portions 13 with heat energy. Referring to FIG. 9B, this melts the area of contact between the joining portions 13 and the electrode plate collector portions 5 and 6 and their surroundings. As a result, the melted portions 15 join the electrode plate collector portions 5 and 6 and the collector plates 11 and 12. The third embodiment has the same advantages as described in the first and second embodiments.

Examples, or test examples, of the present invention will now be described.

A positive electrode plate was formed as follows. Predetermined amounts of a cobalt compound and water were mixed with nickel hydroxide particles containing cobalt and zinc in the form of a solid solution. The mixture was then kneaded to form a paste. Next, the paste was filled in a porous body formed from foam nickel. The nickel porous body had a porosity of 95% and surface density of 450 g/m². Further, the nickel porous body included an electrode plate collector portion formed by seam-welding and adhering a nickel plate to one of the long sides of the porous body. The nickel porous body was dried, pressurized, and cut into predetermined dimensions (thickness of 0.4 mm, width of 35 mm, and length of 85 mm) to form a positive electrode plate having a theoretical capacity of 700 mAh. The positive electrode plate was covered by a sulfonated polypropylene separator with only the electrode plate collector portion left in an exposed state. This formed a separator-added positive electrode plate.

A negative electrode plate was formed in the next manner. Predetermined amounts of a binder and a conductive material were mixed with a hydrogen storing alloy (an MmNi_{3.6}Co_{0.7}Mn_{0.4}Al_{0.3}, Mm: misch metal). The mixture was then kneaded to form a paste. Next, the paste was applied to a punching metal having a thickness of 0.08 mm and including an electrode plate collector portion formed in the same manner as in the positive electrode plate described above. The punching metal was then dried, pressurized, and cut into predetermined dimensions (thickness of 0.4 mm, width of 35 mm, and length of 85 mm) to form a negative electrode plate having a theoretical capacity of 750 mAh.

An electrode plate group was formed by alternately superimposing five positive electrode plates and six negative electrode plates, which were formed as described above, with the electrode plate corrector portions projecting from opposite sides. Collector plates of examples 1 to 4 and comparative examples 1 and 2, which are described below, were joined to the two sides of these electrode plate groups. Dimensions that are not otherwise specified for the collector plates of examples 2 to 4 and comparative examples 1 and 2 are identical to the corresponding dimensions of the collector plates in example 1.

Example 1 has the structure shown in FIG. 5A. The plate thickness t at the joining portions is 0.7 mm. The height s of the joining portions is 2.0 mm.

Example 2 has the structure shown in FIG. 7A. The plate thickness t at the joining portions is 0.35 mm.

Example 3 has the structure shown in FIG. 7A. The plate thickness t at the joining portions is 0.2 mm.

Example 4 has the structure shown in FIG. 9A.

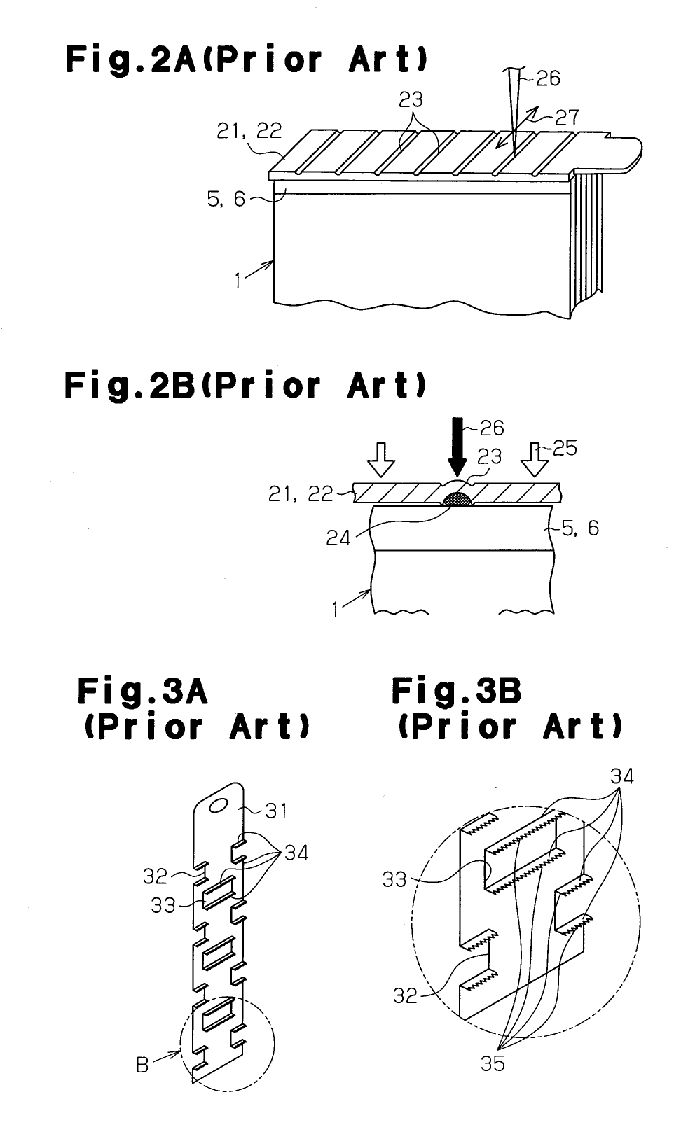

Comparative example 1 has the structure shown in FIG. 2A.

Comparative example 2 has the structure shown in FIG. 3A.

Each of the electrode plate groups to which the collector plates of the examples and the comparative examples are joined was inserted into a rectangular resin battery jar made of polypropylene. Upper portions of the collector plates joined to each electrode plate group were connected to a terminal unit of an external power supply. Then, 10 ml of an electrolyte, which was mainly composed of a sodium hydroxide solution, was injected into the resin-made battery jar. Afterwards, a resin lid was welded to the jar to seal the resin-made battery jar. In this manner, nickel-metal hydride batteries for test purposes having a theoretical capacity of 3500 mAh were formed. The batteries using the collector plates of example 1, example 2, example 3, example 4, comparative example 1, and comparative example 2 are respectively referred to as battery A, battery B, battery C, battery D, battery E, and battery F.

Test batteries A to F of examples 1 to 4 and comparative examples 1 and 2 were charged and discharged under predetermined activation conditions. Then, the internal resistance of each battery was measured under the temperatures of 25° C. and −30° C. In detail, the battery was charged at 25° C. with a constant current to obtain a state of charge (SOC) of 60%. Next, discharging pulses and charging pulses were repeatedly applied to the battery under each temperature. The voltage of the battery was measured every ten seconds after the application of each discharging pulse, and the measured voltage was plotted relative to the current value. Then, the least-square method was carried out with the plotted values. The gradient of an approximate straight line was used to calculate the internal resistance of the battery. Table 1 shows the measurement results.

TABLE 1

| | 25° C. | −30° c. |
|---|---|---|
| Battery A | 4.2 mΩ | 27.6 mΩ |
| Battery B | 4.3 mΩ | 28.2 mΩ |
| Battery C | 5.0 mΩ | 32.9 mΩ |
| Battery D | 4.2 mΩ | 27.8 mΩ |
| Battery E | 5.1 mΩ | 34.1 mΩ |
| Battery F | 5.3 mΩ | 35.5 mΩ |

As table 1 shows, the internal resistance of batteries A to D using the collector plates of examples 1 to 4 is equal to or less than the internal resistance of the battery of comparative example 1 (battery E), which uses the conventional wax, and much more less than the internal resistance of the battery of comparative example 2 (battery F). Further, although the test results of the battery of example 3 (battery C), of which the joining portions have a plate thickness that is one-third the original thickness or smaller, are equivalent to the test results of the battery of comparative example 1 (battery E), the test results of the batteries of the other examples (batteries A, B, and D) are superior to the test results of the battery of comparative example 1 (battery E).

Although the above embodiments describe examples in which the present invention is applied to a nickel-metal hydride battery, the same results are obtained when the present invention is applied to rectangular batteries, such as a nickel-cadmium battery and a lithium-ion battery.

As described above, the rechargeable battery of the present invention bends the collector plates to form the joining portions joined to the electrode plate collector portions. This reduces the electric resistance of the collector plates and reduces the cost for the joining of the collector plates and the electrode plate collector portions. Further, in a state in which the joining portions are pressed into the electrode plate collector portions, the joining portions are melted to join the collector plates and the electrode plate collector portions. This reduces the joining resistance of the collector plates and the electrode plate collector portions. As a result, the present invention provides a rechargeable battery having a small internal resistance with a low cost. The present invention also provides various types of rechargeable batteries, especially, rechargeable batteries for power supplies requiring high output and high performance.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

What is claimed is:

1. A rechargeable battery comprising:
an electrode plate group having a first edge and a second edge and including a positive electrode plate having a positive electrode plate collector portion defined on the first edge and a negative electrode plate having a negative electrode plate collector portion defined on the second edge;
a first collector plate joined to the positive electrode plate collector portion; and
a second collector plate joined to the negative electrode plate collector portion;
wherein each of the first and second collector plates includes a joining portion formed by bending a predetermined part of the collector plate so that the joining portion has a ridge-shaped cross-section, the joining portion being pressed into and joined to the corresponding electrode plate collector portion.

2. The rechargeable battery according to claim 1, wherein each of the first and second collector plates is formed by a metal plate.

3. The rechargeable battery according to claim 1, wherein each of the positive and negative electrode plate collector portions includes a recess for receiving a distal end of the corresponding joining portion.

4. The rechargeable battery according to claim 2, wherein the joining portion has a thickness, the metal plate has a plate thickness, and the thickness of the joining portion is at least one-third the plate thickness of the metal plate.

5. The rechargeable battery according to claim 1, wherein the joining portion has a distal end formed into an acute end.

6. The rechargeable battery according to claim 1, wherein the joining portion includes inner surfaces that come in contact with each other.

7. The rechargeable battery according to claim 1, further comprising:
a melted portion formed through welding to join the joining portion to the corresponding electrode plate collector portion.

8. A method for manufacturing a rechargeable battery, the method comprising:
preparing an electrode plate group having a first edge and a second edge, wherein the electrode plate group includes a positive electrode plate having a positive electrode plate collector portion defined on the first edge and a negative electrode plate having a negative electrode plate collector portion defined on the second edge;
preparing a first collector plate joined to the positive electrode plate collector portion and a second collector plate joined to the negative electrode plate collector portion, wherein each of the first and second collector plates are formed from a metal plate;
forming a joining portion having a ridge-shaped cross-section on each of the first and second collector plates by bending a predetermined part of each of the first and second collector plates;
forcing the first collector plate against the positive electrode plate collector portion and the second collector plate against the negative electrode plate collector portion to press the joining portion of each of the first and second collector plates into the corresponding electrode plate collector portion; and
joining each of the first and second collector plates to the corresponding electrode plate collector portion by melting an area of contact between the joining portions of each of the first and second collector plates and the corresponding electrode plate collector portion and the vicinity thereof.

9. The method according to claim 8, further comprising:
forming a recess for receiving a distal end of the corresponding joining portion in each of the positive and negative electrode plate collector portions.

10. The method according to claim 8, further comprising:
forming an acute end on the joining portion.

11. The method according to claim 8, wherein said forming a joining portion includes bending each collector plate so that the joining portion includes inner surfaces that come in contact with each other.

12. The method according to claim 8, wherein each of the first and second collector plates includes a plurality of the joining portions, and said joining includes:
pressing a welding electrode against the rear of two different joining portions formed in each collector plate and performing welding so that welding current flows between the two different joining portions and melts the area of contact between the joining portions of each of the first and second collector plates and the corresponding electrode plate collector portion and the vicinity thereof.

13. The method according to claim 8, wherein said joining includes emitting a laser beam or an electron beam toward the rear of the joining portion of the first and second collector plate to heat and melt a distal end of the joining portion and the corresponding electrode plate collector portion.

14. A collector plate for a rechargeable battery provided with an electrode plate group having a first edge and a second edge and including a positive electrode plate having a positive electrode plate collector portion defined on the first edge and a negative electrode plate having a negative electrode plate collector portion defined on the second edge, the collector plate comprising:
a metal plate including a predetermined part; and
a joining portion formed by the predetermined part of the collector plate so that the joining portion has a ridge-shaped cross-section, the joining portion being joinable to the positive electrode plate collector portion or the negative electrode plate collector portion.

15. The collector plate according to claim 14, wherein the joining portion has a thickness, the metal plate has a plate thickness, and the thickness of the joining portion is at least one-third the plate thickness of the metal plate.

16. The collector plate according to claim 14, wherein the joining portion has a distal end formed into an acute end.

17. The collector plate according to claim 14, wherein the joining portion includes inner surfaces that come in contact with each other.
